(19) United States
(12) Patent Application Publication
(10) Pub. No.: US 2013/0189793 A1
(43) Pub. Date: Jul. 25, 2013

(54) Stable Colloidal Suspensions Of Gold Nanoconjugates And The Method For Preparing The Same

(71) Applicants: Wei Qian, Ann Arbor, MI (US); Yong Che, Ann Arbor, MI (US)

(72) Inventors: Wei Qian, Ann Arbor, MI (US); Yong Che, Ann Arbor, MI (US)

(21) Appl. No.: 13/744,633

(22) Filed: Jan. 18, 2013

Related U.S. Application Data
(60) Provisional application No. 61/588,750, filed on Jan. 20, 2012.

(51) Int. Cl. G01N 21/64

(52) U.S. Cl. CPC G01N 21/64
USPC 436/172

(57) ABSTRACT

In the present invention, a method for determining the stability threshold amount of a stabilizer component for gold nanoparticles to prevent their aggregation in any electrolyte solution, is disclosed. The method permits for very low levels of stabilizer components to be used while still permitting conjugation with other functional ligands. The method comprises preparation of stable gold nanoparticles conjugated with different amount of stabilizing agents in deionized water first and then testing the stability of colloidal suspension of these gold nanoparticles in the presence of the electrolyte solution by monitoring the absorbance at 520 nm. The invention also comprises a method for fabrication of nanoconjugates comprising gold nanoparticles and only the stabilizer components or comprising gold nanoparticles, stabilizer components and functional ligands, which are stable in the presence of electrolytes.

### RELATED APPLICATIONS

This application claims the benefit of U.S. provisional application Ser. No. 61/588,750 filed Jan. 20, 2012.

### TECHNICAL FIELD

The present invention relates to a method for the preparation of gold nanoconjugates which are stable after exposing said gold nanoconjugates to electrolyte solutions and multifunctional gold nanoconjugates prepared by said method.

### BACKGROUND

Colloidal gold is a dispersion of gold nanoparticles in a dispersion medium, typically water, but other medium can also be used as discussed below. Gold nanoparticles have attracted substantial interest from scientists for over a century because of their unique physical, chemical, and surface properties, such as: (i) size- and shape-dependent strong optical extinction and scattering which are tunable from ultra violate (UV) wavelengths all the way to near infrared (NIR) wavelengths; (ii) large surface areas for conjugation to functional ligands; and (iii) little or no long-term toxicity or other adverse effects in vivo allowing their high acceptance level in living systems. Colloidal gold nanoparticles, also referred to as gold nanocolloids, are now being widely investigated for their potential use in a wide variety of biological and medical applications. Applications include use as an imaging agent, a sensing agent, a gene-regulating agent, a targeted drug delivery carrier, and in photoresponsive therapeutics. Most of these applications require the colloidal gold undergo surface modification, also referred to as surface functionalization, prior to its use in the application.

Currently, the overwhelming majority of gold nanocolloids are prepared by using the standard wet chemical sodium citrate reduction of tetrachloroaurate (HAuCl₄) methodology. This method results in the synthesis of spherical gold nanoparticles with diameters ranging from 5 to 200 nanometers (nm) which are capped or covered with negatively charged citrate ions. The citrate ion capping prevents the nanoparticles from aggregating by providing electrostatic repulsion. Once formed and prior to their use in biological and medical applications the sodium citrate capped gold nanoparticles must undergo further surface functionalization, usually via conjugation of functional ligand molecules to the surface of the nanoparticle.

Other wet chemical methods for formation of colloidal gold include the Brust method, the Perrault method and the Martin method. The Brust method relies on reaction of chlorauric acid with tetraoctylammonium bromide in toluene and sodium borohydride. The Perrault method uses hydroquinone to reduce the HAuCl₄ in a solution containing gold nanoparticle seeds. The Martin method uses reduction of HAuCl₄ in water by NaBH₄ wherein the stabilizing agents HCl and NaOH are present in a precise ratio. All of the wet chemical methods rely on first converting gold (Au) with strong acid into the atomic formula HAuCl₄ and then using this atomic form to build up the nanoparticles in a bottom-up type of process. All of the methods require the presence of stabilizing agents to prevent the gold nanoparticles from aggregating and precipitating out of solution.

On the other hand, over the past few decades, a physical method of making metal nanoparticles based on pulsed laser ablation of a metal target immersed in a liquid has been attracting increasingly widespread interest. In contrast to the chemical procedures, pulsed laser ablation of a metal target immersed in a liquid offers the possibility of generating stable nanocolloids while avoiding chemical precursors, reducing agents, and stabilizing ligands, all of which could be problematic for the subsequent functionalization and stabilization of the nanoparticles. Therefore, since it was pioneered by Henglein and Fojtik for preparing nano-size particles in either organic solvents or aqueous solutions as well as by Cotton for preparation of water-borne surface-enhanced Raman scattering active metallic nanoparticles with bare surfaces in 1993, the application of pulsed laser ablation of metal targets in liquids has gained much interest, especially after the advent of femtosecond lasers, which are capable of eliminating some problems associated with the use of nanosecond lasers. Compared to laser ablation with pulses of longer duration, e.g. nanoseconds, the irradiation of metal targets by femtosecond laser pulses offers a precise laser-induced breakdown threshold and can effectively minimize the heat affected zones since the femtosecond laser pulses release energy to electrons in the target on a time-scale much faster than electron-phonon thermalization processes. Characterized by its simplicity of the procedure, versatility with respect to metals or solvents, and the nanoparticle growth in a controllable, contamination-free environment, pulsed laser-induced ablation from solid targets has evolved as one of the most important physical method for obtaining colloidal metallic nanoparticles.

Once the stabilized colloidal gold nanoparticles are formed further modification/functionalization of surface of nanoparticles with stabilizing agents and biorecognization molecules must occur before the nanoparticles can be used in their many practical biomedical applications and potential applications, including biological imaging and detection, gene-regulation, drug delivery vectors, and diagnostic or therapeutic agents for treatment of cancer in humans. The surface modification/functionalization also must not result in destabilization of the colloidal suspension and precipitation of the gold nanoparticles. Although various surface modification/functionalization strategies, including additional coating, ligand modification, and ligand exchange, have been established, the synthesis of functionalized gold nanoparticles still presents a major challenge, especially when it is desired to conjugate a defined number of one or multiple types of biomolecules onto the surface of individual gold nanoparticles, which would be very beneficial for many applications and fundamental studies.

In most cases, gold nanoparticles that are surface-functionalized with functional ligands such as biomolecules have to be dispersed into biological buffers to maintain the properties and functions of these biomolecules. The colloidal gold nanoparticles remain suspended in a pure aqueous solution by their mutual electrostatic repulsion due to the negative charge present on each gold nanoparticle's surface. After transferring the gold nanoparticles from the pure aqueous solution into an aqueous biological buffer, the electrolytes present in biological buffers cause the negatively charged colloidal gold nanoparticles to draw together, aggregate, and to ultimately precipitate out of the solution irreversibly. Therefore, it is challenging to stabilize gold nanoparticles that are surface-functionalized with biomolecules in aqueous biological buffers.

In the present invention, we provide a new method that addresses the issues and challenges described above and demonstrate how to use this method to fabricate gold nanoconjugates, gold nanoparticles with solubilizer components and/or functional ligands conjugated onto their surface, which are stable even after exposing them to electrolyte containing solutions. Although, it is known that there are stabilizer components that can be used to prevent aggregation in electrolyte containing solutions, the work in the past has had to use very high levels of these stabilizer components which causes its own issues. Prior to the present invention, there was no way to know how much stabilizer component must be bound to the surface of gold nanoparticles to maintain their stability after exposing them to electrolyte solutions. Since the colloidal gold nanoparticles used in our experiments were fabricated by femtosecond laser ablation of gold targets in deionized water, the produced gold nanoparticles have a bare surface and are in a contamination-free environment which allows us to carry out controllable surface modification/functionalization and the amount of surface coverage by modifying ligands can be tuned to be any percent value between 0 and 100%. By taking advantage of this unique property provided by colloidal gold nanoparticles produced by femtosecond laser ablation of gold targets in deionized water, we have observed and can determine a stability threshold amount of stabilizer component that must be present and bound to the surface of gold nanoparticles to keep them stable and suspended in an electrolyte solution with or without the presence of other functional ligands bound to surface of the same gold nanoparticles.

Thus, the fabrication of gold nanoconjugates which will be stable in the presence of electrolytes comprises adding to a colloidal suspension of gold nanoparticles in an aqueous solution free of electrolytes one or multiple types of stabilizer components which bind to the surface of the gold nanoparticles with the total amount of the stabilizer component being equivalent to or above the stability threshold amount. In addition, by keeping the amount of stabilizer component below the amount required to form a monolayer over 100 percent of the surface of the gold nanoconjugate we are also able to conjugate other functional ligands to the stabilized gold nanoconjugates. In both cases, the stabilizer component or the functional ligand could either be directly bound to the surface of the gold nanoparticles via a functional group having an affinity for the gold nanoparticles or indirectly bound to surface of the gold nanoparticles by involving an integrating molecule that binds to both the functional ligand or stabilizer component and either the gold nanoparticle or another molecule bound to the gold nanoparticle. Finally, the formed gold nanoconjugates can be extracted from the solution and exist in the form of a powder or being redispersed into electrolyte solutions.

### SUMMARY OF THE INVENTION

The present invention relates to a method for determining a stability threshold amount of stabilizer components which are bound to the surface of gold nanoparticles and which stabilize them from precipitation and aggregation in electrolyte solutions. The stabilized gold nanoparticles can also accommodate binding of other functional ligands in addition to the stabilizer components allowing for use in biological systems. The nanoconjugates having a size in at least one dimension of from 1 to 200 nanometers and are stable in the presence of electrolytes for use in biological, medical, and other applications.

In one aspect, the present invention is directed to a stable chemical or biochemical reagent comprising gold nanoparticles having conjugated to their surface a stabilizing amount of a stabilizer component permitting for stability in the presence of electrolyte solutions.

In another aspect, the present invention is directed to a stable chemical or biochemical reagent comprising gold nanoparticles having conjugated to their surface a stabilizing amount of a stabilizer component permitting for stability in the presence of electrolyte solutions and at least one type of functional ligand also bound to their surface.

### BRIEF DESCRIPTION OF THE DRAWINGS

FIG. 1 schematically illustrates a laser-based ablation system for the top-down production of gold nanoparticles in a liquid in accordance with the present invention;

FIG. 2 illustrates the UV-VIS absorption spectrum of a stable bare colloidal gold preparation prepared according to the present invention by a laser ablation of a bulk gold target in deionized water and a transmission electron microscopy (TEM) picture of these stable bare colloidal gold nanoparticles is shown in the inset;

FIG. 3 displays the UV-VIS absorption spectra of a colloidal gold preparation prepared according to the present invention mixed with various amounts of a stabilizer component, thiolated polyethyleneglycol

FIG. 4a displays the colloidal stability of PEGylated gold nanoparticles prepared in accordance with the present invention at various ratios of thiolated PEG to gold nanoparticles in the presence of 1% NaCl, characterized by absorbance of localized surface plasmon resonance of the gold nanoparticles at 520 nanometers;

FIG. 4b illustrates the size increase of the hydrodynamic diameter measured by dynamic light scattering (DLS) of PEGylated gold nanoparticles prepared according to the present invention at various ratios of thiolated PEG to gold nanoparticles;

FIG. 5a displays the fluorescence spectra of various mixtures of Rhodamine labeled PEG with Au nanoparticles prepared according to the present invention and FIG. 5b illustrates the fluorescence intensity at 570 nm of these mixtures as a function of initial input ratio between the number of Rhodamine labeled PEG molecules and the number of Au nanoparticles in the mixed solution;

FIG. 6 displays the size increase of hydrodynamic diameter measured by dynamic light scattering (DLS) of PEGylated gold nanoparticles prepared according to the present invention at various ratios of thiolated PEG to gold nanoparticles for PEG with molecule weights ranging from 5 kiloDaltons (kDa) to 20 kDa;

FIG. 7 displays the normalized size increase of hydrodynamic diameter measured by dynamic light scattering (DLS) of PEGylated gold nanoparticles prepared according to the present invention at increasing ratios of thiolated PEG to gold nanoparticles for two different sized gold nanoparticles;

FIG. 8 displays the colloidal stability of PEGylated gold nanoparticles prepared in accordance with the present invention at various ratios of thiolated PEG to gold nanoparticles in phosphate buffered saline (PBS), characterized by absorbance of localized surface plasmon resonance of the gold nanoparticles at 520 nanometers;

FIG. 9 displays the colloidal stability of gold nanoparticles conjugated with both thiolated PEG and a cystein RGD peptide prepared in accordance with the present invention in phosphate buffered saline (PBS), characterized by absorbance of localized surface plasmon resonance of the gold nanoparticles at 520 nanometers;

FIG. 10 displays the colloidal stability of gold nanoparticles conjugated with both thiolated PEG and nuclear localization signal (NLS) peptide prepared in accordance with the present invention in phosphate buffered saline (PBS), characterized by absorbance of localized surface plasmon resonance of the gold nanoparticles at 520 nanometers; and

FIG. 11 shows the data from FIG. 8, FIG. 9, and FIG. 10 in graphical form to compare colloidal stability of the three preparations.

### DETAILED DESCRIPTION

Gold nanocolloids have attracted strong interest from scientists for over a century and are now being heavily investigated for their potential use in a wide variety of medical and biological applications. For example, potential uses include surface-enhanced spectroscopy, biological labeling and detection, gene-regulation, and diagnostic or therapeutic agents for treatment of cancer in humans. Their versatility in a broad range of applications stems from their unique physical, chemical, and surface properties, such as: (i) size- and shape-dependent strong optical extinction and scattering at visible and near infrared (NIR) wavelengths due to a localized surface plasmon resonance of their free electrons upon excitation by an electromagnetic field; (ii) large surface areas for conjugation to functional ligands; and (iii) little or no long-term toxicity or other adverse effects in vivo allowing their high acceptance level in living systems.

These new physical, chemical, and surface properties, which are not available from either atomic or bulk counterparts, explain why gold nanocolloids have not been simply chosen as alternatives to molecule-based systems but as novel structures which provide substantive advantages in biological and medical applications.

As discussed above, the overwhelming majority of gold nanocolloids are prepared by the standard sodium citrate reduction reaction. This method allows for the synthesis of spherical gold nanoparticles with diameters ranging from 5 to 200 nanometers (nm) which are capped with negatively charged citrate ions. The capping controls the growth of the nanoparticles in terms of rate, final size, geometric shape and stabilizes the nanoparticles against aggregation by electrostatic repulsion.

While such wet chemical prepared gold nanocolloids may be stable for years in the as-synthesized solution, they immediately aggregate irreversibly in the presence of salts or other electrolytes. In the presence of elevated salt concentrations, the electrostatic repulsion from the citrate is shielded and the gold nanoparticles can easily come close enough to each other to be within the range of the van der Waals force which causes the nanoparticles to agglomerate. Thus, as-synthesized citrate-capped gold nanocolloids are not stable in biological environments such as in the presence of strong acids, strong bases, or concentrated salts and therefore they are not suitable for the applications mentioned above in the areas of biology and medicine.

The prerequisite for most of their intended biological and medical applications is the further surface modification of the as-synthesized citrate-capped gold nanoparticles via conjugation of functional ligand molecules to the surface of the gold nanoparticles. The surface functionalization of gold nanoparticles for any biological or medical applications is crucial for at least two reasons. First is control over the interaction of the nanoparticles with their environment, which is naturally taking place at the nanoparticle surface. Appropriate surface functionalization is a key step to providing stability, solubility, and retention of physical and chemical properties of the nanoparticles in the physiological conditions. Second, the ligand molecules provide additional and new properties or functionality to those found inherently in the core gold nanoparticle. These conjugated gold nanoparticles bring together the unique properties and functionality of both the core material and the ligand shell for achieving the goals of highly specific targeting of gold nanoparticles to the sites of interest, ultra-sensitive sensing, and effective therapy.

Nowadays, the major strategies for surface modification of inorganic colloidal nanoparticles include ligand exchange, ligand modification, and additional coating. Among these strategies the ligand exchange reaction has proven to be a particularly powerful approach to incorporate functionality onto nanoparticles and is widely used to produce organic- and water-soluble nanoparticles with various core materials and functional groups. In the ligand exchange reaction, the original ligand molecules on the surfaces of nanoparticles are exchanged with other ligands to provide new properties or functionality to the nanoparticles. In the most cases, the incoming ligand molecule binds more strongly to the nanoparticle surface than the leaving ligand, which allows colloidal stability of the nanoparticles to be maintained during the reaction. While this is, in principle, well understood and described by theory, the full scope, exact processes, and the microscopic nature of the ligand exchange reactions involving nanoparticles have not been determined and are still subject to research and discussion. These reactions are complex because the nanoparticles, conjugating ligands, additives, residues from the nanoparticle synthesis, and the nature of the solvent all play important roles in the ligand exchange reaction.

Factors that affect surface functionalization of gold nanocolloids produced by wet chemical methods via ligand exchange reactions have been extensively investigated with the objective of optimizing such processes. Various chemical functional groups, such as thiol, amine, and phosphine, possess a high affinity for the surface of gold nanoparticles. Thiol groups are considered to show the highest affinity for gold surfaces, approximately 200 kJ/mol, and therefore a majority of gold nanoparticle surface functionalization occurs through using ligand molecules having thiol groups which bind to surfaces of gold nanoparticles via a thiol-Au bond.

In contrast to the prior process of bottom-up fabrication using wet chemical processes, gold nanocolloids used in the present invention are produced by a top-down nanofabrication approach. The top-down fabrication methods of the present invention start with a bulk material in a liquid and then break the bulk material into nanoparticles in the liquid by applying physical energy to the material. The physical energy can be mechanical energy, heat energy, electric field arc discharge energy, magnetic field energy, ion beam energy, electron beam energy, or laser beam energy including laser ablation of the bulk material. The present process produces a pure, bare colloidal gold nanoparticle that is stable in the ablation liquid and avoids the wet chemical issues of residual chemical precursors, stabilizing agents and reducing agents. The ablation liquid is an electrolyte free liquid, thus the nanoparticles are stable in this liquid as formed by the present process, they still must be modified to achieve stability in the presence of electrolytes.

Gold nanocolloids produced by a top-down nanofabrication approach described in the present invention allows for production of stable gold nanocolloids with only partial surface modification to be fabricated. Also, the surface coverage amount of functional ligands on the surfaces of the fabricated gold nanoparticle conjugates can be tuned to be any percent value between 0 and 100%. All of these unique properties are available because bare gold nanoparticles used in the present invention produced by top-down nanofabrication approach produces are stable in the liquid they are created in with no need for stabilizing agents.

Among the molecules used for surface functionalization/stabilization of gold nanoparticles, polyethyleneglycol (PEG), or more specifically thiolated polyethyleneglycol (SH-PEG), is one of the more important and widely used species. As discussed elsewhere in the present specification many other ligands can be used to functionalize the present colloidal gold preparations, generally through binding at a thiol functionality on the ligand.

PEG is a linear polymer consisting of repeated units of —CH₂—CH₂—O—. Depending on the molecular weight, the same molecular structure is also termed poly(ethylene oxide) or polyoxyethylene. The polymer is very soluble in a number of organic solvents as well as in water. After being conjugated onto the surfaces of gold nanoparticles, in order to maximize entropy, the PEG chains have a high tendency to fold into coils or bend into a mushroom like configuration with diameters much larger than proteins of the corresponding molecular weight. The surface modification of gold nanoparticles with PEG is often referred to as ‘PEGylation’ and in the present specification and claims binding of PEG to gold nanoparticles will be referred to as PEGylation. Since the layer of PEG on the surface of gold nanoparticles can help to stabilize the gold nanoparticles in an aqueous environment by providing a stearic barrier between interacting gold nanoparticles, PEGylated gold nanoparticles are much more stable at high salt concentrations, the amount of PEG used in these prior stabilization studies is very high compared to the level of nanoparticles and this raises issues with its use. In addition to PEG, other non-ionic hydrophilic polymers, proteins, or other stabilizing agents can be used to stabilize the gold nanoparticles. In some embodiments, mixtures of stabilizing components are useful.

The PEG chains also provide reactive sites for adding other targeting or signaling functionality to PEGylated gold nanoparticles prepared according to the present invention. For example, these reactive sites can be used to bind fluorescent markers for detection and signaling functions to the gold nanoparticles.

Since high levels of PEGylation are currently an effective means to enhance stability of gold nanoparticles in the presence of electrolytes when the nanoparticles are prepared by wet chemical methods the use of PEGylation was investigated in top-down fabricated gold nanoparticles. More specifically, femtosecond laser ablation of a gold target in deionized water is carried out first and the produced bare gold nanoparticles were used to investigate the effects of PEGylation on stability of the nanoparticles in the electrolyte solution of phosphate buffered saline (PBS).

A first step in the present invention is the finding that stable colloidal suspensions of bare gold nanoparticles can be created by a top-down fabrication method in situ in a suspension medium in the absence of stabilizing agents. Colloidal gold nanoparticles exhibit an absorbance peak in the wavelength range of 518 to 530 nanometers (nm). The term “stable” as applied to a colloidal gold preparation prepared according to the present invention refers to stability of the absorbance intensity caused by localized surface plasmon resonance of a bare colloidal gold preparation at 518 to 530 nm, more specifically at 520 nm upon storage. Generally, if a colloidal gold preparation becomes unstable the gold nanoparticles begin to aggregate and precipitate out of the suspension over time, thus leading to a decrease in the absorbance at 518-530 nm. In addition, “stable” means that there is a minimal red shift or change in localized surface plasmon resonance of 2 nanometers or less over storage time. The term “bare” as applied to the colloidal gold nanoparticles prepared according to the present invention means that the nanoparticles are pure gold with no surface modification or treatment other than creation as described in the liquid. The bare gold nanoparticles are also not in the presence of any stabilizing agents, they are simply in the preparation liquid which does not contain any nanoparticle stabilizers such as citrate.

There are a variety of top-down nanofabrication approaches that can be used in the present invention. All, however, require that the generation of the nanoparticles from the bulk material occur in the presence of the suspension medium. In one embodiment the process comprises a one step process wherein the application of the physical energy source, such as mechanical energy, heat energy, electric field arc discharge energy, magnetic field energy, ion beam energy, electron beam energy, or laser energy to the bulk gold occur in the suspension medium. The bulk source is placed in the suspension medium and the physical energy is applied thus generating nanoparticles that are immediately suspended in the suspension medium as they are formed. In another embodiment the present invention is a two-step process including the steps of: 1) fabricating gold nanoparticle arrays on a substrate by using photo, electron beam, focused ion beam, nanoimprint, or nanosphere lithography as known in the art; and 2) removing the gold nanoparticle arrays from the substrate into the suspension liquid using one of the physical energy methods. Tabor, C., Qian, W., and El-Sayed, M. A., Journal of Physical Chemistry C, Vol 111 (2007), 8934-8941; Haes, A. J.; Zhao, J.; Zou, S. L.; Own, C. S.; Marks, L. D.; Schatz, G. C.; Van Duyne, R. P. Journal Of Physical Chemistry B, Vol 109 (2005), 11158. In both methods the colloidal gold is formed in situ by generating the nanoparticles in the suspension medium using one of the physical energy methods.

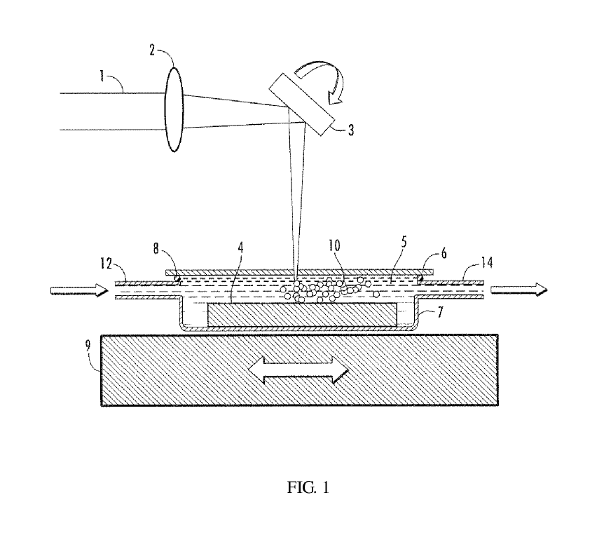

In at least one embodiment of the present invention, gold nanocolloids were produced by pulsed laser ablation of a bulk gold target in deionized water as the suspension medium. FIG. 1 schematically illustrates a laser-based system for producing colloidal suspensions of nanoparticles of complex compounds such as gold in a liquid using pulsed laser ablation in accordance with the present invention. In one embodiment a laser beam 1 is generated from an ultrafast pulsed laser source, not shown, and focused by a lens 2. The source of the laser beam 1 can be a pulsed laser or any other laser source providing suitable pulse duration, repetition rate, and/or power level as discussed below. The focused laser beam 1 then passes from the lens 2 to a guide mechanism 3 for directing the laser beam 1. Alternatively, the lens 2 can be placed between the guide mechanism 3 and a target 4 of the bulk material. The guide mechanism 3 can be any of those known in the art including piezo-mirrors, acousto-optic deflectors, rotating polygons, a vibration mirror, or prisms. Preferably the guide mechanism 3 is a vibration minor 3 to enable controlled and rapid movement of the laser beam 1. The guide mechanism 3 directs the laser beam 1 to a target 4. In one embodiment, the target 4 is a bulk gold target. The target 4 is submerged a distance, from several millimeters to preferably less than 1 centimeter, below the surface of a suspension liquid 5. The target 4 is positioned in a container 7 additionally but not necessarily having a removable glass window 6 on its top. Optionally, an O-ring type seal 8 is placed between the glass window 6 and the top of the container 7 to prevent the liquid 5 from leaking out of the container 7. Additionally but not necessarily, the container 7 includes an inlet 12 and an outlet 14 so the liquid 5 can be passed over the target 4 and thus be re-circulated. The container 7 is optionally placed on a motion stage 9 that can produce translational motion of the container 7 with the target 4 and the liquid 5. Flow of the liquid 5 is used to carry the nanoparticles 10 generated from the target 4 out of the container 7 to be collected as a colloidal suspension. The flow of liquid 5 over the target 4 also cools the laser focal volume. The liquid 5 can be any liquid that is largely transparent to the wavelength of the laser beam 1, and that serves as a colloidal suspension medium for the target material 4. In one embodiment, the liquid 5 is deionized water having a resistivity of greater than 0.05 MOhm.cm, and preferably greater than 1 MOhm.cm. The system thus allows for generation of colloidal gold nanoparticles in situ in a suspension liquid so that a colloidal gold suspension is formed. The formed gold nanoparticles are immediately stably suspended in the liquid and thus no dispersants, stabilizer agents, surfactants or other materials are required to maintain the colloidal suspension in a stable state. This result was unexpected and allows the creating of a unique colloidal gold suspension that contains bare gold nanoparticles.

The following laser parameters were used to fabricate gold nanocolloids by pulsed laser ablation of a bulk gold target in deionized water: pulse energy of 10 uJ (micro Joules), pulse repetition rate of 100 kHz, pulse duration of 700 femtoseconds, and a laser spot size on the ablation target of about 50 um (microns). For the preparation of Au nanocolloids according to the present invention, a 16 mm (millimeter) long, 8 mm wide, and 0.5 mm thick rectangular target of Au from Alfa Aesar was used. For convenience, the Au target materials can be attached to a bigger piece of a bulk material such as a glass slide, another metal substrate, or a Si substrate.

More generally, for the present invention the laser ablation parameters are as follows: a pulse duration in a range from about 10 femtoseconds to about 500 picoseconds, preferably from about 100 femtoseconds to about 30 picoseconds; the pulse energy in the range from about 1 μJ to about 100 μJ; the pulse repetition rate in the range from about 10 kHz to about 10 MHz; and the laser spot size may be less than about 100 μm. The target material has a size in at least one dimension that is greater than a spot size of a laser spot at a surface of the target material.

Samples of colloidal gold nanoparticles prepared by laser ablation in deionized water according to the present invention were characterized by an array of commercially available analytic instruments and techniques, including UV-VIS absorption spectra, dynamic light scattering (DLS), and transmission electron microscopy (TEM). UV-VIS absorption spectra were recorded with a Shimadzu UV-3600 UV-VIS-NIR spectrophotometer. DLS measurements were performed using a Nano-ZS90 Zatasizer (Malvern Instrument, Westborough, Mass.). Gold nanoparticles were visualized using transmission electron microscopy (TEM; JEOL 2010F, Japan) at an accelerating voltage of 100 kV. All measurements and processes were carried out at room temperature, approximately 25° C.

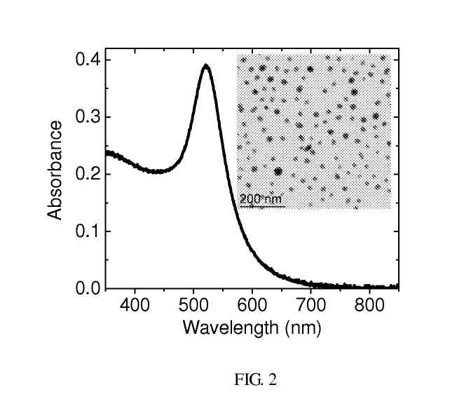

FIG. 2 shows the UV-VIS absorption spectrum and TEM picture of a stable bare colloidal gold nanoparticle preparation prepared by laser ablation in deionized water according to the present invention. The maximum of localized surface plasmon resonance of the colloidal gold nanoparticle preparation according to the present invention is at 520 nm. The average Feret diameter of the nanoparticles was determined to be 20.8 nm as measured from TEM images like the one shown in the inset.

Thiolated PEG (SH-PEG) with a molecular weight of 20 kDa, from Sigma Aldrich, product number 63753-250MG, was used without further purification. The PEGylation of gold nanoparticles was carried out by adding different amounts of the thiolated PEG into the colloidal gold samples in the deionized water. The final ratio between the number of thiolated PEG molecules with a molecular weight of 20 kDa and the number of Au nanoparticles (NP) in the mixed solution, determined by correlating their measured extinction, UV-VIS, spectroscopy data to the extinction coefficient of 20 nm Au nanoparticles (8×10⁸ mol⁻¹ cm⁻¹), was varied from 10 to 4000. After mixing, each solution was kept undisturbed for at least 24 hours at room temperature to provide a sufficient amount of time for PEG molecules to be conjugated onto the surfaces of the Au nanoparticles via Au-thiol bonding before characterizing the colloidal stability of the Au nanoparticles under PEGylation.

The colloidal stability of the colloidal Au nanoparticle preparation under PEGylation was evaluated by measuring the UV-VIS absorption spectroscopy, which is considered to be the most appropriate technique due to the existence of intense localized surface plasmon resonance of Au nanoparticles around 520 nm, of the preparations. The aggregation and/or precipitation of gold nanoparticles will be reflected by a decrease of the absorption around 520 nm.

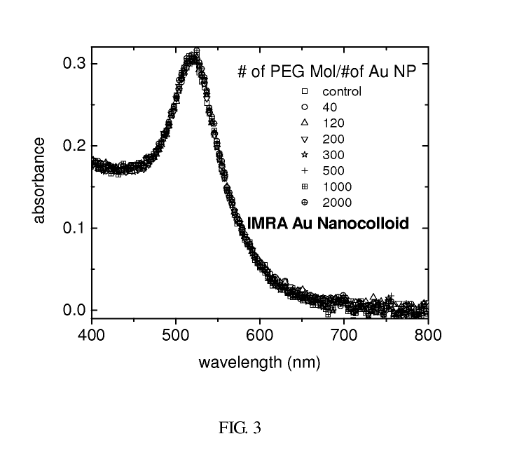

FIG. 3 displays the UV-VIS absorption spectra of the various gold nanocolloids prepared by laser ablation in deionized water according to the present invention after mixing with thiolated PEG at different concentrations and then letting them sit for at least 24 hours. It is shown that for the PEGylation of the Au nanocolloids prepared according to the present invention, the mixing with various amounts of thiolated PEG induced a negligible change in the spectrum as compared with that of the Au nanocolloid without adding PEG, which served as a control sample. All the spectra of PEGylated Au nanocolloids prepared according to the present invention are almost the same as that of the control sample. There are no detectable red shifts or decreases of localized surface plasmon resonance in all the spectra of these samples. The lack of any loss of the intensity around 520 nm and lack of a red shift reveals the superior colloidal stability of colloidal gold prepared according to the present invention during the PEGylation process in deionized water.

Since the colloidal stability is perfectly maintained during the PEGylation of colloidal gold prepared according to the present invention, this process allows one to prepare stable PEGylated Au nanocolloids having a defined number of conjugated PEG molecules on them ranging in amount from 1% or less to the number necessary for forming a complete monolayer on the surface of the gold nanoparticles.

Thiolated PEG molecules are used as an example for describing the conjugation of surface modifying molecules, such a stabilizer components, to the gold nanoparticles in the colloidal gold prepared according to the present invention. In fact, any functional ligand containing at least one functional group which exhibits affinity for gold surfaces, such as thiol groups, amine groups, or phosphine groups, could be conjugated to the surfaces of gold nanoparticles prepared using the method described above. This method allows one to produce stable gold nanocolloids with partial or full surface modification and thus the surface coverage of ligand on surfaces of gold nanoparticles can be tuned to be any percentage value between 0 and 100%.

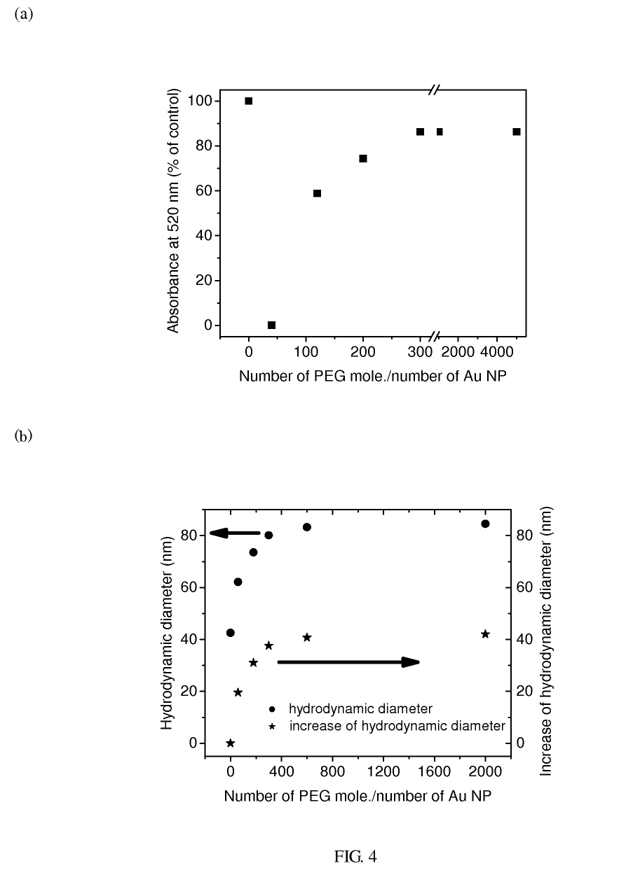

The number of thiolated PEG 20 k molecules necessary to form a complete monolayer on the surface of colloidal gold nanoparticles prepared according to the present invention can be determined. Due to the charge screening effect, as-synthesized gold nanocolloids prepared by both the present method and by the wet chemical approach will form aggregates at elevated salt concentrations. The layer of PEG molecules on the surface of gold nanoparticles can improve the stability of the gold nanoparticles in the presence of high levels of NaCl by providing a stearic repulsion between the nanoparticles and this stability approaches a maximum as the Au nanoparticle surface is completely coated with a layer of PEG molecules. Therefore, monitoring the stability, by measuring the absorbance at 520 nm, of PEGylated colloidal gold nanoparticles prepared according to the present invention in the presence of a high level of the salt NaCl can be used to determine the minimum amount of PEG molecules necessary to form a complete monolayer on the gold nanoparticle surface. Samples of colloidal gold nanoparticles prepared according to the present invention, having a diameter of 20 nm as described above, were PEGylated in the presence of ratios of thiolated PEG to Au nanoparticles of from 40 to 5000. NaCl was added to each sample to a final concentration of 1 weight percent (1%) to trigger aggregation/precipitation. FIG. 4A displays the absorbance of PEGylated Au nanocolloids at 520 nm expressed as a percentage of the control sample obtained without adding NaCl. It is shown that the stability of PEGylated Au nanoparticles drops, indicating aggregation, at low levels of PEG/Au and then increases and approaches a maximum at a PEG/Au ratio of 300 to 1. Increasing the PEG/Au ratio beyond 300 to up to 5000 PEG per Au nanoparticle does not further increase stability of the colloidal suspension. This indicates that the minimum number of PEG molecules necessary for forming a complete monolayer on the surface of a bare gold nanoparticle with diameter of 20 nm prepared according to the present invention is about 300.

Dynamic light scattering (DLS) was also used to verify the minimum number of thiolated PEG 20 kDa molecules necessary to form a complete monolayer on the surface of colloidal gold nanoparticles with an average diameter of 20 nm prepared according to the present invention by monitoring the size increase of the nanoparticles after PEGylation. Nanoparticles grow bigger as more PEG molecules are conjugated onto their surfaces. Use of DLS is considered by many to be a standard method for measuring the average nanoparticle size because of its wide availability, simplicity of sample preparation and measurement, relevant size range measurement from 1 nm to about 2 um, speed of measurement, and in situ measurement capability for fluid-born nanoparticles. FIG. 4B displays the results of both total size in the solid circles and the size increase in the solid stars of colloidal gold nanoparticles prepared according to the present invention that were PEGylated at the indicated ratios of thiol PEG to Au nanoparticles. It is shown that the total size and the increase in size approaches a maximum at a PEG/Au ratio of about 300 to 1 and that use of PEG at a level up to about 10 fold of this number had little additional effect on increasing the nanoparticle size. Again, the DLS measurement confirms that the minimum PEG molecule to Au ratio necessary for forming a complete monolayer on the surface of colloidal gold nanoparticles with an average diameter of 20 nm prepared according to the present invention is about 300. This result is consistent with the result of the stability test using 1% NaCl as reported in FIG. 4A.

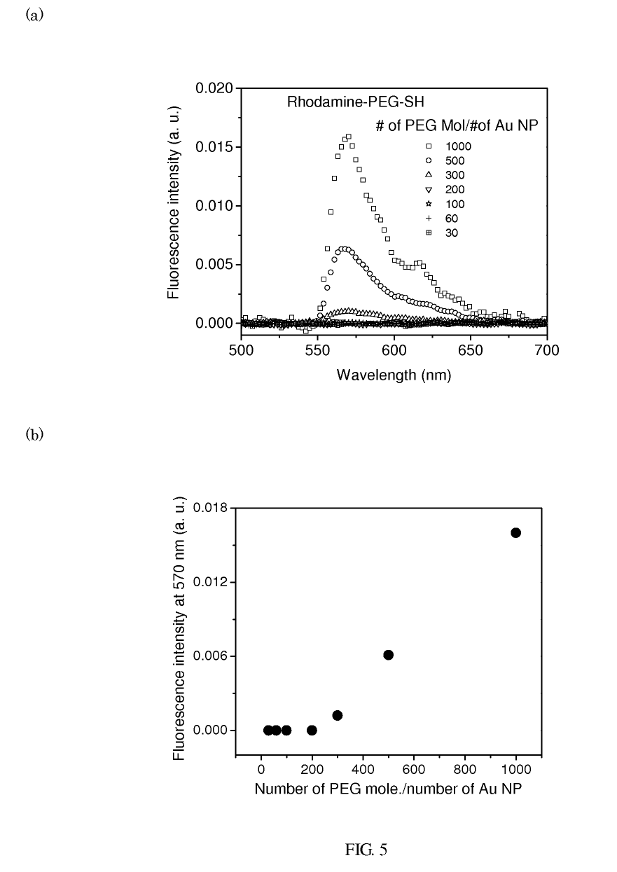

A third method was used to determine the minimum number of thiolated PEG molecules necessary to form a complete monolayer on the surface of colloidal gold nanoparticles prepared according to the present invention. Again the colloidal gold nanoparticles had an average diameter of 20 nm. In this measurement fluorescently tagged PEG molecules were used. The thiolated PEG was 10 kDa and it was tagged with Rhodamine. It is well known that gold nanoparticles quench almost all fluorescence from fluorescent molecules bound to their surfaces. Therefore it is expected that at low ratios of Rhodamine labeled PEG to Au nanoparticles there should be very little fluorescence as they will all be bound and therefore quenched. As the ratio of Rhodamine labeled PEG to Au nanoparticles increases it should reach a point where there are free Rhodamine labeled PEG since all the binding sites on the Au nanoparticles are occupied. At that ratio one should begin to detect fluorescence. In this measurement the Rhodamine labeled PEG was mixed with colloidal gold nanoparticles prepared according to the present invention at a series of ratios as shown in FIG. 5a. FIG. 5a displays the fluorescence spectrum from several solutions of gold nanoparticles conjugated with Rhodamine label thiolated PEG 10 kDa molecules. It is seen that fluorescence was only detected from the solution of gold nanoparticle-Rhodamine labeled PEG 10 kDa conjugates if the initial input PEG/Au ratio was above 300 PEG per Au nanoparticle. The result indicates that only as the PEG/Au ratio is above 300, are there free unbound PEG molecules in the solution. We did not observe any fluorescence when the PEG/Au ratio was 200, which indicates that all the Rhodamine labeled PEG 10 kDa molecules added to the gold nanocolloid were bound to the surfaces of nanoparticles. In FIG. 5b the intensity of the fluorescence peak at 570 nm for all the ratios is also plotted. Again this shows that no fluorescence is observed until the ratio is above 300 and thereafter it increases linearly. This again confirms that the minimum number of PEG molecules necessary for forming a complete monolayer on the surface of colloidal gold nanoparticles prepared according to the present invention with an diameter of 20 nm is about 300.

The footprint size of a thiol group on the surface of a gold nanoparticle has been determined by others using thiol-terminated oligonucleotides. Hill, H. D., Millstone, J. E., Banholzer, M. J., and Mirkin, C. A., ACS Nano, Vol. 3 (2009), 418-424. The footprint value depends on the diameter of the gold nanoparticles. For a nanoparticle size of 20 nm, it is 7.0+/−1 nm². Therefore, for a spherical gold nanoparticle with a diameter of 20 nm, the minimum number of thiol-terminated molecules necessary to form a complete monolayer on the surface of the gold nanoparticle is theoretically about 180+/−20 by referring to this literature value, which is fairly close to the results from the three other measures described above.

All three methods described above for determining the minimum number of thiol-terminated molecules necessary to form a complete monolayer on the surface of colloidal gold nanoparticles prepared according to the present invention are important. The same processes can be carried out for other functional ligands or stabilizer components to determine their footprint sizes. Knowing this minimum number, one can create conjugation reactions wherein the amount of surface coverage is set at any level from 0 to 100% coverage thereby enabling tunable conjugation. One can add mixtures of ligands and be certain of the ratio that should appear on the final conjugated Au nanoparticle.

Because the present invention allows one to prepare bare stable colloidal gold nanoparticles and since one can measure the surface area thereby determining the amount of a first ligand required for any coverage of from 0 to 100%, the colloidal gold nanoparticles prepared according to the present invention can be used to conjugate a second type of ligand with a different functionality from the first to the same nanoparticle. Therefore, stable colloidal gold nanoparticles conjugated with two or more different ligands with different functionalities could be fabricated by employing this protocol.

In the data described in this specification, thiolated PEG 20 kDa molecules or thiolated Rhodamine labeled PEG 10 kDa molecules were used, these were chosen for illustration purposes only. The invention is not limited to use with thiolated PEG molecules as either the stabilizer component or as a functional ligand. Because the invention produces bare stable colloidal gold nanoparticles, any ligand having a functional group that can bind to Au particle surfaces can be used such as the suggested thiol groups, amine groups, or phosphine groups. This also makes colloidal gold nanoparticles prepared according to the present invention very attractive for use in binding aptamers and other rare or expensive ligands. The aptamers can be deoxyribonucleic acid (DNA) or ribonucleic acid (RNA) or amino acid sequences as is known in the art. The present colloidal gold can also be used to bind to antibodies, enzymes, proteins, peptides and other reporter or ligand materials that are rare or expensive. The ligands can include any fluorescent marker having a group or bound to a group that can be conjugated to a Au nanoparticle.

In addition, all kinds of PEG molecules, comprising mono-, homo-, and heterofunctional PEG with different functional groups and one or multiple arms and molecular weights ranging from 200 Da to 100,000,000 Da can also be used for the surface modification reaction. In the case of using heterofunctional PEG, the functional groups, for example a carboxyl group COOH and an amine group NH₂, not used to bind to the Au nanoparticle could be used for binding to other functional groups on other ligands. This opens a wide range of possibilities for other functionalities to be added to the Au nanoparticles.

In the present specification the concentration has been on colloidal Au nanoparticles, however, since the PEGylation process can be used for many other metals it is expected that the present top-down fabrication method can also be applied to other metals which can then be partially or fully surface modified using the processes described herein. For example, the metals and materials can be chosen from, but not limited to, Cr, Mn, Fe, Co, Ni, Pt, Pd, Ag, Cu, Silicon, CdTe, and CdSe.

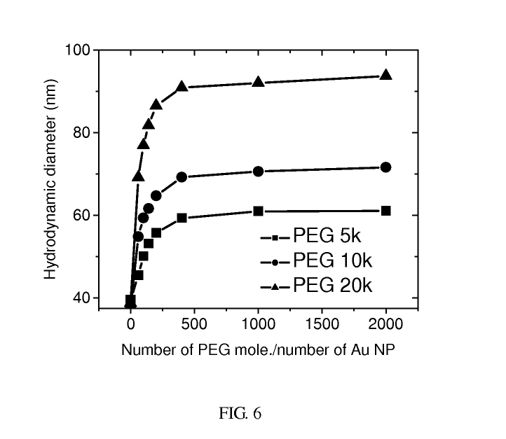

In addition, we have studied whether or not the minimum number of PEG molecules necessary for forming a complete monolayer on the surface of colloidal gold nanoparticles prepared according to the present invention with an diameter of 20 nm depends on the molecule weight of thiolated PEG. FIG. 6 displays the size increase of hydrodynamic diameter measured by dynamic light scattering (DLS) of PEGylated gold nanoparticles prepared according to the present invention at various ratios of thiolated PEG to gold nanoparticles (NP) for PEG with molecule weights of 5 kDa, 10 kDa or 20 kDa. The data indicates that the minimum number of PEG molecules necessary for forming a complete monolayer on the surface of colloidal gold nanoparticles determined by the footprint of thiolated PEG on gold nanoparticle is independent of PEG molecule weight since all three PEG molecules reach maximal diameter at the same ratio of PEG/Au.

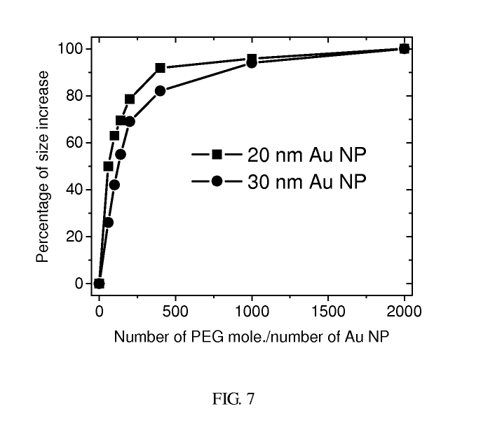

Furthermore, we have studied whether or not the minimum number of PEG molecules necessary for forming a complete monolayer on the surface of colloidal gold nanoparticles prepared according to the present invention depends on the original diameter of gold nanoparticles. FIG. 7 displays the normalized size increase of hydrodynamic diameter measured by dynamic light scattering (DLS) of PEGylated gold nanoparticles prepared according to the present invention at increasing ratios of thiolated PEG to gold nanoparticles (NP). The thiolated PEG used here has molecular weight of 10 kDa and the original diameters of the gold nanoparticles prepared according to the present invention were 20 nm and 30 nm, respectively. The data indicates that the 30 nm diameter particle required a higher ratio of PEG/Au to achieve maximal diameter, meaning 100% monolayer coverage. Larger nanoparticles require a higher amount of PEG 10 kDa for providing monolayer coverage because of the larger surface area for coverage as expected.

In the present invention, we have focused not only on the fabrication of gold nanoparticles conjugated one or more different functional ligands but also their stability in the presence of electrolytes. Gold nanoparticles that are surface-functionalized with biomolecules have to be dispersed into biological buffers in order to maintain properties and functions of these biomolecules. In most cases, although gold nanoparticles that are surface-functionalized with biomolecules are stable in the aqueous solution containing no or very few ions such as deionized water, after transferring the gold nanoparticles into a biological buffer, aggregation and precipitation of these gold nanoparticles occurs. The colloidal gold nanoparticles are suspended in non-electrolyte aqueous solutions by their mutual electrostatic repulsion due to the negative charge present on each gold nanoparticle's surface, the electrolytes present in that biological buffer cause the negatively charged colloidal gold nanoparticles to draw together, to aggregate, and to ultimately precipitate out of the solution.

Since the colloidal gold nanoparticles used in our experiments fabricated by laser ablation in deionized water according to the present invention allows us to carry out controllable surface modification/functionalization and the amount of surface coverage by modifying ligands can be tuned to be any percent value between 0 and 100%, we have been able to develop a process which allows us to determine a stability threshold amount of stabilizer component that must be present to permit stability of the nanoparticles in an electrolyte solution while still preserving free space on the nanoparticle to permit binding of additional functional ligands. As discussed above in the past this was not possible, instead the process was to use a large excess of stabilizer component and hope that it could be displaced by additional functional ligands without causing precipitation, which is irreversible. Our process permits very low levels of stabilizer to be used with full confidence that the nanoparticles will be stable when they are subsequently transferred to an electrolyte solution.

Thiolated PEG 5 kDa was selected as an example molecule to serve as the stabilizer component in these experiments, as described throughout the specification other stabilizer components can be used alone and in combinations. The PEGylation of gold nanoparticles with diameter of 20 nm fabricated by laser ablation according to the present invention was carried out first in the deionized water by adding different amounts of the thiolated PEG 5 kDa into the colloidal suspension of gold nanoparticles in aqueous solution. The final ratio between the number of thiolated PEG molecules with a molecular weight of 5 kDa and the number of Au nanoparticles in the mixed solution, determined by correlating their measured extinction (uv-vis) spectroscopy data to the extinction coefficient of 20 nm Au nanoparticles (8×10⁸ mol⁻¹ cm⁻¹), and was varied from 20 to 1000. After mixing, each solution was kept undisturbed for at least 24 hours at room temperature, 25° C., to provide a sufficient amount of time for the PEG molecules to be conjugated onto the surfaces of the Au nanoparticles via Au-thiol bonding before collection of PEGylated gold nanoparticles in each solution by centrifuge at 20000 g for 30 minute, removing the supernatant, and then redispersing into a phosphate buffered saline (PBS). Two hours after being redispersed into PBS buffers, the colloidal stability of PEGylated gold nanoparticles with various ratios of thiolated PEG to gold nanoparticles is characterized by absorbance of localized surface plasmon resonance of the gold nanoparticles at 520 nanometers.

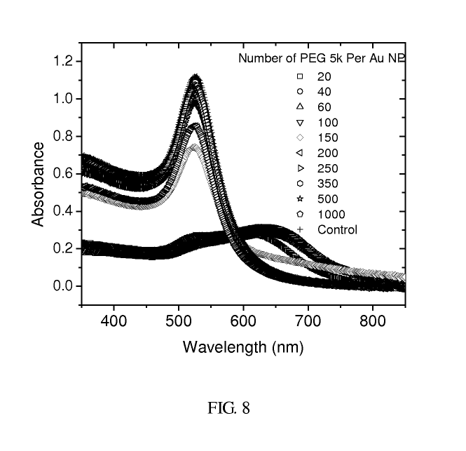

FIG. 8 displays the colloidal stability of PEGylated gold nanoparticles prepared in accordance with the present invention at various ratios of thiolated PEG to gold nanoparticles in phosphate buffered saline (PBS) buffer, characterized by absorbance of localized surface plasmon resonance of the gold nanoparticles at 520 nanometers. A transition from unstable colloidal suspension of PEGylated gold nanoparticles to stable colloidal suspension of PEGylated gold nanoparticles in PBS occurred when the ratio of thiolated PEG to gold nanoparticles was above 150 to 1. This is seen by the increase in absorbance at 520 nm, which reaches that of the control solution as the ratio of thiolated PEG to Au nanoparticles increases.

In the present invention, we have also fabricated gold nanoconjugates comprising gold nanoparticles conjugated with both thiolated PEG 5 kDa as a stabilizer component and one of two peptides as additional functional ligands. The two types of peptides selected in our experiments were cystein (RGD)₄ with an amino acid sequence of RGDRGDRGDRGDC, using the standard single letter designations for amino acids, and nuclear localization signal (NLS) peptide derived from SV-40 large T antigen with an amino acid sequence of CGGFSTSLRARKA. The cystein (RGD)₄ peptide is for targeting of integrin, a cancer marker that is overexpressed on the cytoplasmic membrane of most types of cancer cells and NLS is a peptide for targeting the cell nucleus.

The conjugation of both thiolated PEG 5 kDa and cystein (RGD)₄ or NLS onto gold nanoparticles with a diameter of 20 nm fabricated by laser ablation according to the present invention was carried out first in the deionized water by adding different amounts of the thiolated PEG 5 kDa and a fixed amount of cystein (RGD)₄ or NLS in sequence into the colloidal suspension of gold nanoparticles in the aqueous solution. First the different amounts of thiolated PEG 5 kDa were added into colloidal suspensions of gold nanoparticles and two hours later, either cystein (RGD)₄ or NLS peptides were added to each at a fixed amount. The final ratio between the number of thiolated PEG molecules with a molecular weight of 5 kDa and the number of Au nanoparticles in the mixed solution, determined by correlating their measured extinction (uv-vis) spectroscopy data to the extinction coefficient of 20 nm Au nanoparticles (8×10⁸ mol⁻¹ cm⁻¹), was varied from 20 to 1000. By using the same method, the final ratio between the number of cystein (RGD)₄ or NLS peptides and the number of Au nanoparticles in the mixed solution was determined to be 500 per Au nanoparticle. After mixing with both thiolated PEG 5 kDa and cystein (RGD)₄ or NLS peptides, each solution was kept undisturbed for at least 24 hours at room temperature to provide a sufficient amount of time for the thiolated PEG molecules and cystein (RGD)₄ or NLS peptides to be conjugated onto the surfaces of the Au nanoparticles via Au-thiol bonding before collection of PEGylated cystein (RGD)₄ or NLS conjugated gold nanoparticles in each solution by centrifuge at 20000 g for 30 minutes, removing the supernatant, and then redispersing into phosphate buffered saline (PBS). Two hours after being redispersed into PBS, the colloidal stability of PEGylated cystein (RGD)₄ or NLS conjugated gold nanoparticles with various ratios of thiolated PEG to gold nanoparticles and the fixed ratio of cystein (RGD)₄ or NLS to gold nanoparticles was characterized by absorbance of localized surface plasmon resonance of the gold nanoparticles at 520 nanometers.

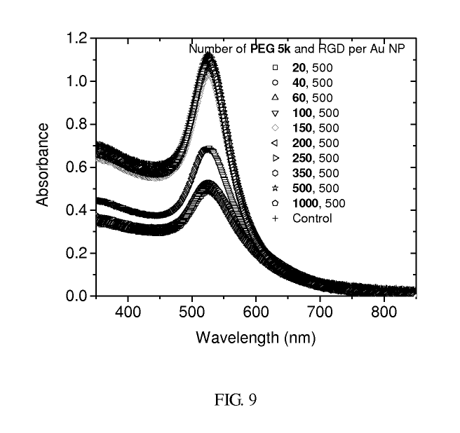

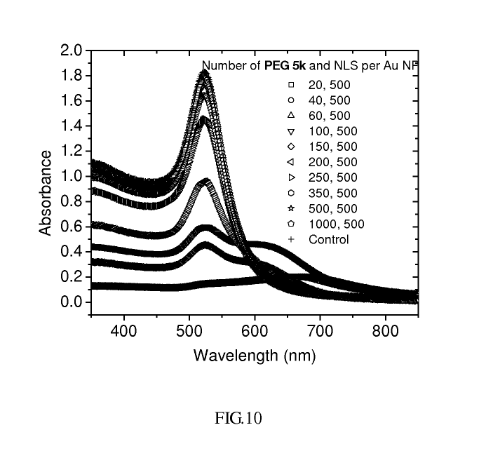

FIGS. 9 and 10 display the colloidal stability of PEGylated cystein (RGD)₄ conjugated gold nanoparticles and PEGylated NLS conjugated gold nanoparticles in phosphate buffered saline (PBS), respectively, characterized by absorbance of localized surface plasmon resonance of the gold nanoparticles at 520 nanometers. For these colloidal suspensions of gold nanoparticles conjugated with both thiolated PEG 5 k and cystein (RGD)₄ or NLS peptides, the ratio of thiolated PEG to gold nanoparticles varies from 20 to 1000 and the ratio of cystein (RGD)₄ or NLS peptides to gold nanoparticles is fixed at 500. A transition from unstable colloidal suspension of PEGylated cystein (RGD)₄ conjugated gold nanoparticles to stable colloidal suspension of PEGylated cystein (RGD)₄ conjugated gold nanoparticles in PBS occurred when the ratio of thiolated PEG to gold nanoparticles was above 100 for PEGylated cystein (RGD)₄ conjugated gold nanoparticles. The transition from unstable to stable colloidal suspension in PBS for PEGylated NLS conjugated gold nanoconjugates occurred when the ratio of thiolated PEG to Au nanoparticles was above 200 for PEGylated NLS conjugated gold nanoparticles.

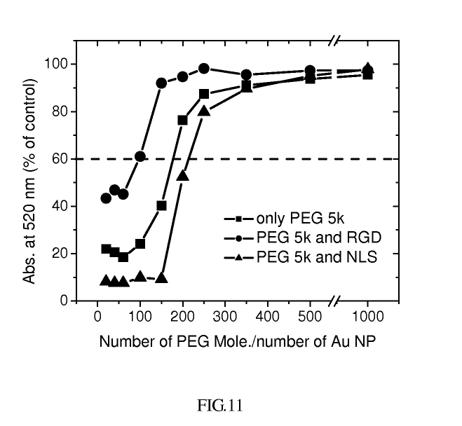

FIG. 11 shows the data from FIG. 8, FIG. 9, and FIG. 10 in graphical form to compare colloidal stability for the gold nanoparticles conjugated with only thiolated PEG, gold nanoparticles conjugated with both thiolated PEG and cystein (RGD)₄ peptides, and gold nanoparticles conjugated with both thiolated PEG and NLS peptides prepared in accordance with the present invention in phosphate buffered saline (PBS), characterized by absorbance of localized surface plasmon resonance of the gold nanoparticles at 520 nanometers. It is revealed that in all three cases, there are transitions from unstable colloidal solutions of gold nanoconjugates to stable colloidal solutions of gold nanoconjugates in PBS as the ratio of thiolated PEG to gold nanoparticles approaches or goes beyond a certain number. The ability to detect the ratio where the colloidal solutions go from unstable to stable allows our method to be used to form very stable solutions with minimal levels of stabilizer components such that there is still sufficient room on the surface of the gold nanoparticles to allow for conjugation of additional functional ligands. This was not previously possible.

Based on the results shown in FIG. 11 and other data, a stability threshold amount of a stabilizer component, in this case thiolated PEG, can be determined for a population of gold nanoparticles in an electrolyte solution. The stability threshold amount of a stabilizer component is defined as the amount of stabilizer component that must be present to prevent a decrease of more than 40% of the absorbance value of localized surface plasmon resonance of the gold nanoparticles at 520 nanometers, indicated by the dashed line in the FIG. 11, and a detectable red shift of the localized plasmon resonance intensity of no more than 6 nm. Meaning the conjugated nanoparticles are stable in a given electrolyte solution as long as the absorbance at 520 nm is 60% or more of the control value in the absence of the electrolytes and that there is a red shift of no more than 6 nm. Preferably the decrease is no more than 30% and the red shift is no more than 3 nm. While these values may seem arbitrary they are not, they provide for sufficient stability while maintaining open surface for the binding of other functional ligands and also allow for a broader range of electrolyte levels to be covered by a single stabilized preparation. The upper limit on the amount of stabilizer component that would be used is something less than the amount that provides for a monolayer or 100% coverage of the nanoparticles since this would leave no room for binding of other functional ligands. The amount that would provide 100% monolayer can be determined by any of the methods described above wherein the footprint was determined for thiolated PEG. It is obvious that the stability threshold amount of thiolated PEG bound to gold nanoparticle at which transition of the stability occurs is different for the three cases shown in FIG. 11. This is a reflection of the effect of the presence of the other functional ligands, namely the cystein (RGD)₄ and NLS Thus, the stability threshold will vary by the identity of the stabilizer components, the identity of the other functional ligands and their levels of use, the identity and ionic strength of the electrolyte solution; however the present invention provides for a fast and efficient way to determine the stability threshold for any combination of stabilizer components, functional ligands and electrolyte solutions. It is anticipated that similar electrolyte solutions will require similar stability threshold amounts of a given stabilizer component.

In the present invention, the stabilizer component thiolated PEG 5 kDa and the functional ligands cystein (RGD)₄ and NLS peptides are conjugated to gold nanoparticles via thiol-Au bonds which bind them directly onto the surface of the gold nanoparticles. However, both stabilizer components and functional ligands could be either directly bound to surface of gold nanoparticles via a functional group having an affinity for gold nanoparticles or indirectly bound to surface of gold nanoparticles by involving integrating molecules that bind to both the stabilizer component or functional; ligand and either the gold nanoparticle or another molecule bound to the gold nanoparticle. Finally, the formed gold nanoconjugates, either just bound to the stabilizer component or bound to both stabilizer components and functional ligands, can be extracted from their colloidal suspensions and exist in the form of a powder or being redispersed into electrolyte solutions for storage.

Examples of integrating molecules that can be used in the present invention include antibody-antigen pairs, enzyme-substrate pairs, receptor-ligand pairs, streptavidin-biotin pairs, and 1-ethyl-3-[3-dimethylaminopropyl]carbodiimide hydrochloride (EDC) and N-hydroxysulfosuccinimide (sulfo-NHS) coupling or a mixture thereof.

In the present invention, PBS was selected as a test electrolyte solution; however it is obvious from the procedure that we have developed that any electrolyte solution can be created and then tested in the procedure to develop a stabilizer component that will stabilize the gold nanoparticles in the electrolyte solution. Examples of common electrolyte solutions other than PBS that can be used include any of the many buffer solutions for High Performance Capillary Electrophoresis (HPCE) which are known to those of skill in the art, hydroxyethyl piperazineethane sulfonic acid (HEPES) sodium salt solution, citrate-phosphate-dextrose solution used for blood studies and solutions, phosphate buffer solutions, sodium acetate acetic acid solutions, sodium chloride solutions, sodium DL-lactate solutions, tris(hydroxymethyl)aminomethane ethylenediamine tetraacetic acid buffer solutions (Tris-EDTA), and Tris-buffered saline solutions. These are just some common examples, but as noted above any electrolyte solution can be created and tested using the method developed in this invention.

Examples of functional ligands other than peptides that can be used include polymers, deoxyribonucleic acid (DNA) sequences, ribonucleic acid (RNA) sequences, aptamers, amino acid sequences, proteins, peptide-nucleic acid an artificially created polymer similar to RNA and DNA, enzymes, antibodies, fluorescent markers, pharmaceutical compounds or mixtures thereof. Using the present process, once the nanoparticles are conjugated to the desired level of stabilizer component the functional ligands can be conjugated to the stabilized nanoconjugates either in the original suspension liquid or in a desired electrolyte composition. The conjugation is generally carried out by exposure of the stabilized nanoconjugate to the functional ligand at a temperature of 25° C. or less for a period of time of at least 1 hour.

The surface modifications described herein are not limited to application to only spherical colloidal Au nanoparticles having a diameter of from 1 to 200 nanometers. In principle, this method should also work for colloidal Au nanoparticles with other shapes and configurations, including rods, prisms, disks, cubes, core-shell structures, cages, and frames, wherein they have at least one dimension in the range of from 1 to 200 nm. In addition, the method of surface modification described in this invention should also work for nanostructures which have outer surfaces that are only partially covered with gold.

Although the described process of top-down fabrication and surface modification was illustrated in embodiments wherein the liquid was deionized water it is possible to carry out the processes described in other liquids. For example, PEGylation surface modification can be carried out in water, methanol, ethanol, acetone, and other organic solvents.

The PEG used as a stabilizer component can be a thiolated PEG having a molecular weight of from 200 Daltons to 100,000,000 Daltons. It can be a mono-homo or hetero-functional PEG having branches. Examples of polymers other then PEG that can be used as stabilizer components include polyacrylamide, polydecylmethacrylate, polymethacrylate, polystyrene, dendrimer molecules, polycaprolactone (PCL), polylactic acid (PLA), poly(lactic-co-glycolic acid) (PLGA), polyglycolic acid (PGA), and polyhydroxybutyrate (PHB) and mixtures thereof. Other stabilizer components include proteins, non-ionic hydrophilic polymers, antibodies and mixtures of these. The stabilizer components are conjugated to the bare nanoparticles in the suspension solutions, described above in the absence of electrolytes by exposure at a temperature of 25° C. or lower for at least 1 hour.

In one embodiment of the present invention, a multifunctional nanoconjugate prepared by the method described in this invention comprises a gold nanoparticle fabricated by a top-down nanofabrication method using bulk gold as a source material, at least one stabilizer component conjugated to the nanoparticle, and at least one functional ligand, if present, conjugated to the gold nanoparticle. Both the stabilizer component and the functional ligand, if present, each contain at least one functional group having an affinity for the gold nanoparticle and each functional group directly binds the stabilizer component and the functional ligand, if present, onto the surface of the gold nanoparticle. The stabilizer component is present in an amount equal to or greater than the stability threshold amount predetermined by the method also described in this invention but less than an amount required to provide a 100% monolayer coverage of the stabilizer component on the gold nanoparticle based on a footprint of the stabilizer component conjugated to said gold nanoparticle. Depending on the identity of the stabilizer components, the identity and ionic strength of the electrolyte solution, and the identity of the other functional ligands and their levels of use if present, in most cases, the threshold amount of the stabilizer component is an amount in the range of from 20% to 90% of the number of the stabilizer component equivalent to an amount required to provide a 100% monolayer coverage of the stabilizer component on the gold nanoparticle based on a footprint of the stabilizer component conjugated to the gold nanoparticle. The unoccupied sites on the gold nanoparticle, the 80% to 10% not occupied by the stabilizer component, will be used to conjugate at least a second type of functional ligand or more with different functionality from the stabilizer component to the same nanoparticle. Also, amounts of both the stabilizer component and the functional ligand or ligands, if present, bound onto the surface of the gold nanoparticle could be independently adjusted for optimizing both stability and functionality of the gold nanoparticle.

In at least one embodiment, the present invention comprises a method of producing electrolyte stable gold nanoparticles comprising the steps of: a) determining a stability threshold amount of a stabilizer component for a colloidal population of gold nanoparticles in an electrolyte composition; b) conjugating the stabilizer component to the population of gold nanoparticles in a colloidal suspension in the absence of the electrolyte composition, the stabilizer component present in an amount equal to or greater than the stability threshold amount but less than an amount required to provide a 100% monolayer coverage of the stabilizer component on the population of gold nanoparticles as determined based on a footprint analysis of the stabilizer component conjugated to the nanoparticles, thereby forming a population of electrolyte stable gold nanoparticles; and c) optionally, conjugating the population of electrolyte stable gold nanoparticles to at least one functional ligand.

In at least one embodiment, the present invention comprises electrolyte stable gold nanoparticles comprising: a population of gold nanoparticles conjugated to a stabilizer component, the stabilizer component present in an amount equal to or greater than a stability threshold amount but less than an amount required to provide a 100% monolayer coverage of the stabilizer component on the population of gold nanoparticles as determined based on a footprint analysis of the stabilizer component conjugated to the nanoparticles, the nanoparticles conjugated to the stabilizer component being stable to aggregation in an electrolyte solution beyond the stability threshold; and the gold nanoparticles, optionally, additionally conjugated to at least one functional ligand.

In one or more embodiments, the method of producing electrolyte stable gold nanoparticles comprises determining the stability threshold amount of the stabilizer component as the amount of stabilizer component necessary to prevent: a decrease of more than 40% of the localized surface plasmon resonance intensity of the colloidal population of gold nanoparticles conjugated to the stabilizer component and to the functional ligand if present, in the electrolyte composition after 2 hours at 25° C. compared to a localized surface plasmon resonance intensity of the colloidal population of gold nanoparticles conjugated to the stabilizer component and to the functional ligand if present, in the absence of the electrolyte composition; and a detectable red shift of a localized plasmon resonance intensity of more than 6 nanometers of the colloidal population of gold nanoparticles conjugated to the stabilizer component and to the functional ligand if present in the electrolyte composition after 2 hours at 25° C. compared to a localized surface plasmon resonance intensity of the colloidal population of gold nanoparticles conjugated to the stabilizer component and to the functional ligand if present in the absence of the electrolyte composition.

In one or more embodiments, the method of producing electrolyte stable gold nanoparticles comprising determining the stability threshold amount of the stabilizer component as the amount of stabilizer component necessary to prevent: a decrease of more than 30% of the localized surface plasmon resonance intensity of the colloidal population of gold nanoparticles conjugated to the stabilizer component and to the functional ligand if present, in the electrolyte composition after 2 hours at 25° C. compared to a localized surface plasmon resonance intensity of the colloidal population of gold nanoparticles conjugated to the stabilizer component and to the functional ligand if present, in the absence of the electrolyte composition; and a detectable red shift of a localized plasmon resonance intensity of more than 3 nanometers of the colloidal population of gold nanoparticles conjugated to the stabilizer component and to the functional ligand if present in the electrolyte composition after 2 hours at 25° C. compared to a localized surface plasmon resonance intensity of the colloidal population of gold nanoparticles conjugated to the stabilizer component and to the functional ligand if present in the absence of the electrolyte composition.

In one or more embodiments, the method of producing electrolyte stable gold nanoparticles comprising using as the stabilizer component at least one of a non-ionic hydrophilic polymer, a protein, an antibody, or a mixture thereof.

In one or more embodiments, the method of producing electrolyte stable gold nanoparticles comprising using as the stabilizer component at least one of a polymer comprising polyethyleneglycol (PEG), a polyacrylamide, a polydecylmethacrylate, a polystyrene, a dendrimer molecule, a polycaprolactone (PCL), a polylactic acid (PLA), a poly(lactic-co-glycolic acid) (PLGA), a polyglycolic acid (PGA), a polyhydroxybutyrate (PHB), or mixtures thereof.

In one or more embodiments, the method of producing electrolyte stable gold nanoparticles comprising using as the stabilizer component at least one of a polymer comprising a mono-, homo-, or hetero-functional thiolated polyethyleneglycol (PEG) having a molecular weight in the range of from 200 Daltons to 100,000,000 Daltons.

In one or more embodiments, the method of producing electrolyte stable gold nanoparticles comprising using as the colloidal population of gold nanoparticles a population created by a top-down fabrication method comprising applying a physical energy source to a source of bulk gold in a colloidal suspension liquid, the physical energy source comprising at least one of mechanical energy, heat energy, electric field arc discharge energy, magnetic field energy, ion beam energy, electron beam energy, laser ablation, or laser beam energy.

In one or more embodiments, the method of producing electrolyte stable gold nanoparticles comprising the step of first fabricating the source of bulk gold as a gold nanoparticle array on a substrate by photo electron beam deposition, focused ion beam deposition, or nanosphere lithography deposition and then using the gold nanoparticle array on the substrate as the source of bulk gold in the colloidal suspension liquid.

In one or more embodiments, the method of producing electrolyte stable gold nanoparticles comprises using as the colloidal suspension liquid one of deionized water, methanol, ethanol, acetone, or an organic liquid.

In one or more embodiments, the method of producing electrolyte stable gold nanoparticles comprises using as the colloidal population of gold nanoparticles a population wherein the nanoparticles have at least one dimension in the range of from 1 to 200 nanometers.

In one or more embodiments, the method of producing electrolyte stable gold nanoparticles comprises using as the colloidal population of gold nanoparticles a population wherein the shape of the nanoparticles comprises at least one of a sphere, a rod, a prism, a disk, a cube, a core-shell structure, a cage, a frame, or a mixture thereof.

In one or more embodiments, the method of producing electrolyte stable gold nanoparticles comprises using as the electrolyte composition one of a phosphate buffer saline (PBS) solution, a buffer for High Performance Capillary Electrophoresis, a hydroxyethyl piperazineethanesulfonic acid (HEPES) sodium salt solution, a citrate-phosphate-dextrose solution, a phosphate buffer solution, a sodium acetate solution, a sodium chloride solution, a sodium DL-lactate solution, a tris(hydroxymethyl)aminomethane ethylenediaminetetraacetic acid (Tris-EDTA) buffer solution, a tris(hydroxymethyl)aminomethane (Tris) buffered saline, or mixtures thereof.

In one or more embodiments, the method of producing electrolyte stable gold nanoparticles comprises conjugating the stabilizer component to the population of gold nanoparticles in a colloidal suspension liquid comprising deionized water, methanol, ethanol, acetone, or an organic liquid by mixing the population of gold nanoparticles with the stabilizer component in the suspension liquid and then allowing the mixture to remain undisturbed at 25° C. or lower for at least 1 hour.

In one or more embodiments, the method of producing electrolyte stable gold nanoparticles comprises conjugating the functional ligand to the population of gold nanoparticles in a colloidal suspension liquid comprising deionized water, methanol, ethanol, acetone, or an organic liquid by mixing the population of gold nanoparticles with the functional ligand in the suspension liquid and then allowing the mixture to remain undisturbed at 25° C. or lower for at least 1 hour.

In one or more embodiments, the method of producing electrolyte stable gold nanoparticles comprises determining the footprint of the stabilizer component conjugated to the nanoparticles by at least one of: measuring an increase in hydrodynamic diameter as determined by dynamic light scattering following conjugation of the stabilizer component to the population; by measuring the absorbance at 520 nanometers in the presence and absence of 1% by weight of NaCl added to the colloidal suspension following conjugation of the stabilizer component; by fluorescence spectrum analysis after conjugation of a fluorescently labeled stabilizer component to the nanoparticles; by reference to literature values; or by a mixture of these methods.

In one or more embodiments, the method of producing electrolyte stable gold nanoparticles comprises conjugating a functional ligand comprising at least one of a polymer, a deoxyribonucleic acid nucleic acid sequence, a ribonucleic acid sequence, an aptamer, an amino acid sequence, a protein, a peptide, a peptide-nucleic acid, an enzyme, an antibody, an antigen, a fluorescent marker, a pharmaceutical compound, or a mixture thereof.

In one or more embodiments, the method of producing electrolyte stable gold nanoparticles wherein at least one of the stabilizer component or the functional ligand if present is conjugated to the nanoparticles by at least one of a thiol group, an amine group, a phosphine group, an integrating molecule or a mixture thereof.

In one or more embodiments, the method of producing electrolyte stable gold nanoparticles wherein the integrating molecule is selected from the group consisting of an antibody-antigen pair, an enzyme-substrate pair, a receptor-ligand pair, a streptavidin-biotin pair, a 1-ethyl-3-[3-dimethylaminopropyl]carbodiimide hydrochloride (EDC) and N-hydroxysulfosuccinimide (Sulfo-NHS) pairing, and mixtures thereof.

In one or more embodiments, the method of producing electrolyte stable gold nanoparticles comprises after step b) or step c) the further step of removing the electrolyte stable gold nanoparticles from the colloidal suspension and creating a powder of the same.

In one or more embodiments of the electrolyte stable gold nanoparticles the stability threshold amount comprises the amount of the stabilizer component necessary to prevent: a decrease of more than 40% of a localized surface plasmon resonance intensity of a colloidal suspension of the gold nanoparticles conjugated to the stabilizer component and the at least one functional ligand, if present, in an electrolyte composition after 2 hours at 25° C. compared to a localized surface plasmon resonance intensity of a colloidal suspension of the gold nanoparticles conjugated to the stabilizer component and the at least one functional ligand, if present, in the absence of the electrolyte composition; and a detectable red shift of a localized plasmon resonance intensity of more than 6 nanometers of the colloidal suspension of gold nanoparticles after 2 hours at 25° C. in the electrolyte composition.

In one or more embodiments of the electrolyte stable gold nanoparticles the stability threshold amount comprises the amount of the stabilizer component necessary to prevent: a decrease of more than 30% of a localized surface plasmon resonance intensity of a colloidal suspension of the gold nanoparticles conjugated to the stabilizer component and the at least one functional ligand, if present, in an electrolyte composition after 2 hours at 25° C. compared to a localized surface plasmon resonance intensity of a colloidal suspension of the gold nanoparticles conjugated to the stabilizer component and the at least one functional ligand, if present, in the absence of the electrolyte composition; and a detectable red shift of a localized plasmon resonance intensity of more than 3 nanometers of the colloidal suspension of gold nanoparticles after 2 hours at 25° C. in the electrolyte composition.

In one or more embodiments of the electrolyte stable gold nanoparticles the stabilizer component comprises at least one of a non-ionic hydrophilic polymer, a protein, an antibody, or a mixture thereof.

In one or more embodiments of the electrolyte stable gold nanoparticles the stabilizer component comprises at least one of a polymer comprising a polyethyleneglycol (PEG), a polyacrylamide, a polydecylmethacrylate, a polystyrene, a dendrimer molecule, a polycaprolactone (PCL), a polylactic acid (PLA), a poly(lactic-co-glycolic acid) (PLGA), a polyglycolic acid (PGA), a polyhydroxybutyrate (PHB), or mixtures thereof.

In one or more embodiments of the electrolyte stable gold nanoparticles the stabilizer component comprises at least one of a polymer comprising a mono-, homo-, or hetero-functional thiolated polyethyleneglycol (PEG) having a molecular weight in the range of from 200 Daltons to 100,000,000 Daltons.

In one or more embodiments of the electrolyte stable gold nanoparticles the population of gold nanoparticles have been created by a top-down fabrication method comprising applying a physical energy source to a source of bulk gold in a colloidal suspension liquid, the physical energy source comprising at least one of mechanical energy, heat energy, electric field arc discharge energy, magnetic field energy, ion beam energy, electron beam energy, laser ablation, or laser beam energy.

In one or more embodiments of the electrolyte stable gold nanoparticles the additional step of first fabricating the source of bulk gold as a gold nanoparticle array on a substrate by photo electron beam deposition, focused ion beam deposition, or nanosphere lithography deposition and then using the gold nanoparticle array on the substrate as the source of bulk gold in the colloidal suspension liquid is utilized.

In one or more embodiments of the electrolyte stable gold nanoparticles the nanoparticles have at least one dimension in the range of from 1 to 200 nanometers.

In one or more embodiments of the electrolyte stable gold nanoparticles the shape of the nanoparticles comprises at least one of a sphere, a rod, a prism, a disk, a cube, a core-shell structure, a cage, a frame, or a mixture thereof.

In one or more embodiments of the electrolyte stable gold nanoparticles the nanoparticles are stable to aggregation beyond the threshold in an electrolyte composition comprising at least one of a phosphate buffer saline (PBS) solution, a buffer for High Performance Capillary Electrophoresis, a hydroxyethyl piperazineethanesulfonic acid (HEPES) sodium salt solution, a citrate-phosphate-dextrose solution, a phosphate buffer solution, a sodium acetate solution, a sodium chloride solution, a sodium DL-lactate solution, a tris(hydroxymethyl)aminomethane ethylenediaminetetraacetic acid (Tris-EDTA) buffer solution, a tris(hydroxymethyl)aminomethane (Tris) buffered saline, or mixtures thereof.

In one or more embodiments of the electrolyte stable gold nanoparticles the functional ligand comprises at least one of a polymer, a deoxyribonucleic acid nucleic acid sequence, a ribonucleic acid sequence, an aptamer, an amino acid sequence, a protein, a peptide, a peptide-nucleic acid, an enzyme, an antibody, an antigen, a fluorescent marker, a pharmaceutical compound, or a mixture thereof.

In one or more embodiments of the electrolyte stable gold nanoparticles at least one of the stabilizer component or the functional ligand, if present, is conjugated to the nanoparticles by at least one of a thiol group, an amine group, a phosphine group, an integrating molecule or a mixture thereof.

In one or more embodiments of the electrolyte stable gold nanoparticles the integrating molecule is selected from the group consisting of an antibody-antigen pair, an enzyme-substrate pair, a receptor-ligand pair, a streptavidin-biotin pair, a 1-ethyl-3-[3-dimethylaminopropyl]carbodiimide hydrochloride (EDC) and N-hydroxysulfosuccinimide (Sulfo-NHS) pairing, and mixtures thereof.

In one or more embodiments of the electrolyte stable gold nanoparticles the nanoparticles are a powder.

Thus, while only certain embodiments have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

It is intended that the invention be limited only by the claims which follow, and not by the specific embodiments and their variations and combinations as described herein-above.

What is claimed is:

1. A method of producing electrolyte stable gold nanoparticles comprising the steps of:
a) determining a stability threshold amount of a stabilizer component for a colloidal population of gold nanoparticles in an electrolyte composition;
b) conjugating said stabilizer component to said population of gold nanoparticles in a colloidal suspension in the absence of said electrolyte composition, said stabilizer component present in an amount equal to or greater than said stability threshold amount but less than an amount required to provide a 100% monolayer coverage of said stabilizer component on said population of gold nanoparticles as determined based on a footprint analysis of said stabilizer component conjugated to said nanoparticles, thereby forming a population of electrolyte stable gold nanoparticles; and
c) optionally, conjugating to said population of electrolyte stable gold nanoparticles at least one functional ligand.

2. The method of claim 1 wherein step a) comprises determining said stability threshold amount of said stabilizer component as the amount of stabilizer component necessary to prevent:
a decrease of more than 40% of the localized surface plasmon resonance intensity of said colloidal population of gold nanoparticles conjugated to said stabilizer component and to said functional ligand if present, in said electrolyte composition after 2 hours at 25° C. compared to a localized surface plasmon resonance intensity of said colloidal population of gold nanoparticles conjugated to said stabilizer component and to said functional ligand if present, in the absence of said electrolyte composition; and
a detectable red shift of a localized plasmon resonance intensity of more than 6 nanometers of said colloidal population of gold nanoparticles conjugated to said stabilizer component and to said functional ligand if present in said electrolyte composition after 2 hours at 25° C. compared to a localized surface plasmon resonance intensity of said colloidal population of gold nanoparticles conjugated to said stabilizer component and to said functional ligand if present in the absence of said electrolyte composition.

3. The method of claim 2 wherein step a) comprises determining said stability threshold amount of said stabilizer component as the amount of stabilizer component necessary to prevent:
a decrease of more than 30% of the localized surface plasmon resonance intensity of said colloidal population of gold nanoparticles conjugated to said stabilizer component and to said functional ligand if present, in said electrolyte composition after 2 hours at 25° C. compared to a localized surface plasmon resonance intensity of said colloidal population of gold nanoparticles conjugated to said stabilizer component and to said functional ligand if present, in the absence of said electrolyte composition; and
a detectable red shift of a localized plasmon resonance intensity of more than 3 nanometers of said colloidal population of gold nanoparticles conjugated to said stabilizer component and to said functional ligand if present in said electrolyte composition after 2 hours at 25° C. compared to a localized surface plasmon resonance intensity of said colloidal population of gold nanoparticles conjugated to said stabilizer component and to said functional ligand if present in the absence of said electrolyte composition.

4. The method of claim 1 wherein step a) comprises using as said stabilizer component at least one of a non-ionic hydrophilic polymer, a protein, an antibody, or a mixture thereof.

5. The method of claim 4 wherein step a) comprises using as said stabilizer component at least one of a polymer comprising polyethyleneglycol (PEG), a polyacrylamide, a polydecylmethacrylate, a polystyrene, a dendrimer molecule, a polycaprolactone (PCL), a polylactic acid (PLA), a poly(lactic-co-glycolic acid) (PLGA), a polyglycolic acid (PGA), a polyhydroxybutyrate (PHB), or mixtures thereof.

6. The method of claim 5 wherein step a) comprises using as said stabilizer component at least one of a polymer comprising a mono-, homo-, or hetero-functional thiolated polyethyleneglycol (PEG) having a molecular weight in the range of from 200 Daltons to 100,000,000 Daltons.

7. The method of claim 1 wherein step a) comprises using as said colloidal population of gold nanoparticles a population created by a top-down fabrication method comprising applying a physical energy source to a source of bulk gold in a colloidal suspension liquid, said physical energy source comprising at least one of mechanical energy, heat energy, electric field arc discharge energy, magnetic field energy, ion beam energy, electron beam energy, laser ablation, or laser beam energy.

8. The method of claim 7 further comprising the step of first fabricating said source of bulk gold as a gold nanoparticle array on a substrate by photo electron beam deposition, focused ion beam deposition, or nanosphere lithography deposition and then using said gold nanoparticle array on said substrate as said source of bulk gold in said colloidal suspension liquid.

9. The method of claim 7 wherein said colloidal suspension liquid comprises deionized water, methanol, ethanol, acetone, or an organic liquid.

10. The method of claim 1 wherein step a) comprises using as said colloidal population of gold nanoparticles a population wherein said nanoparticles have at least one dimension in the range of from 1 to 200 nanometers.

11. The method of claim 1 wherein step a) comprises using as said colloidal population of gold nanoparticles a population wherein the shape of said nanoparticles comprises at least one of a sphere, a rod, a prism, a disk, a cube, a core-shell structure, a cage, a frame, or a mixture thereof.

12. The method of claim 1 wherein said electrolyte composition comprises a phosphate buffer saline (PBS) solution, a buffer for High Performance Capillary Electrophoresis, a hydroxyethyl piperazineethanesulfonic acid (HEPES) sodium salt solution, a citrate-phosphate-dextrose solution, a phosphate buffer solution, a sodium acetate solution, a sodium chloride solution, a sodium DL-lactate solution, a tris(hydroxymethyl)aminomethane ethylenediaminetetraacetic acid (Tris-EDTA) buffer solution, a tris(hydroxymethyl)aminomethane (Tris) buffered saline, or mixtures thereof.

13. The method of claim 1 wherein step b) comprises conjugating said stabilizer component to said population of gold nanoparticles in a colloidal suspension liquid comprising deionized water, methanol, ethanol, acetone, or an organic liquid by mixing said population of gold nanoparticles with said stabilizer component in said suspension liquid and then allowing said mixture to remain undisturbed at 25° C. or lower for at least 1 hour.

14. The method of claim 1 wherein step c) comprises conjugating said functional ligand to said population of gold nanoparticles in a colloidal suspension liquid comprising deionized water, methanol, ethanol, acetone, or an organic liquid by mixing said population of gold nanoparticles with said functional ligand in said suspension liquid and then allowing said mixture to remain undisturbed at 25° C. or lower for at least 1 hour.

15. The method of claim 1 wherein step b) further comprises determining said footprint of said stabilizer component conjugated to said nanoparticles by at least one of: measuring an increase in hydrodynamic diameter as determined by dynamic light scattering following conjugation of said stabilizer component to said population; by measuring the absorbance at 520 nanometers in the presence and absence of 1% by weight of NaCl added to the colloidal suspension following conjugation of the stabilizer component; by fluorescence spectrum analysis after conjugation of a fluorescently labeled stabilizer component to said nanoparticles; by reference to literature values; or by a mixture of these methods.

16. The method of claim 1 wherein step c) comprises conjugating a functional ligand comprising at least one of a polymer, a deoxyribonucleic acid nucleic acid sequence, a ribonucleic acid sequence, an aptamer, an amino acid sequence, a protein, a peptide, a peptide-nucleic acid, an enzyme, an antibody, an antigen, a fluorescent marker, a pharmaceutical compound, or a mixture thereof.

17. The method of claim 1 wherein at least one of said stabilizer component or said functional ligand if present is conjugated to said nanoparticles by at least one of a thiol group, an amine group, a phosphine group, an integrating molecule or a mixture thereof.

18. The method of claim 17 wherein said integrating molecule is selected from the group consisting of an antibody-antigen pair, an enzyme-substrate pair, a receptor-ligand pair, a streptavidin-biotin pair, a 1-ethyl-3-[3-dimethylaminopropyl]carbodiimide hydrochloride (EDC) and N-hydroxysulfosuccinimide (Sulfo-NHS) pairing, and mixtures thereof.

19. The method of claim 1 further comprising after step b) or step c) the further step of removing the electrolyte stable gold nanoparticles from the colloidal suspension and creating a powder of the same.

20. Electrolyte stable gold nanoparticles comprising:
a population of gold nanoparticles conjugated to a stabilizer component, said stabilizer component present in an amount equal to or greater than a stability threshold amount but less than an amount required to provide a 100% monolayer coverage of said stabilizer component on said population of gold nanoparticles as determined based on a footprint analysis of said stabilizer component conjugated to said nanoparticles, said nanoparticles conjugated to said stabilizer component being stable to aggregation in an electrolyte solution beyond the stability threshold; and
said gold nanoparticles, optionally, additionally conjugated to at least one functional ligand.

21. Electrolyte stable gold nanoparticles as recited in claim 20 wherein said stability threshold amount comprises the amount of said stabilizer component necessary to prevent:
a decrease of more than 40% of a localized surface plasmon resonance intensity of a colloidal suspension of said gold nanoparticles conjugated to said stabilizer component and said at least one functional ligand, if present, in an electrolyte composition after 2 hours at 25° C. compared to a localized surface plasmon resonance intensity of a colloidal suspension of said gold nanoparticles conjugated to said stabilizer component and said at least one functional ligand, if present, in the absence of said electrolyte composition; and
a detectable red shift of a localized plasmon resonance intensity of more than 6 nanometers of said colloidal suspension of gold nanoparticles after 2 hours at 25° C. in said electrolyte composition.

22. Electrolyte stable gold nanoparticles as recited in claim 21 wherein said stability threshold amount comprises the amount of said stabilizer component necessary to prevent:
a decrease of more than 30% of a localized surface plasmon resonance intensity of a colloidal suspension of said gold nanoparticles conjugated to said stabilizer component and said at least one functional ligand, if present, in an electrolyte composition after 2 hours at 25° C. compared to a localized surface plasmon resonance intensity of a colloidal suspension of said gold nanoparticles conjugated to said stabilizer component and said at least one functional ligand, if present, in the absence of said electrolyte composition; and
a detectable red shift of a localized plasmon resonance intensity of more than 3 nanometers of said colloidal suspension of gold nanoparticles after 2 hours at 25° C. in said electrolyte composition.

23. The electrolyte stable gold nanoparticles of claim 20 wherein said stabilizer component comprises at least one of a non-ionic hydrophilic polymer, a protein, an antibody, or a mixture thereof.

24. The electrolyte stable gold nanoparticles of claim 23 wherein said stabilizer component comprises at least one of a polymer comprising a polyethyleneglycol (PEG), a polyacrylamide, a polydecylmethacrylate, a polystyrene, a dendrimer molecule, a polycaprolactone (PCL), a polylactic acid (PLA), a poly(lactic-co-glycolic acid) (PLGA), a polyglycolic acid (PGA), a polyhydroxybutyrate (PHB), or mixtures thereof.

25. The electrolyte stable gold nanoparticles of claim 24 wherein said stabilizer component comprises at least one of a polymer comprising a mono-, homo-, or hetero-functional thiolated polyethyleneglycol (PEG) having a molecular weight in the range of from 200 Daltons to 100,000,000 Daltons.

26. The electrolyte stable gold nanoparticles of claim 20 wherein said population of gold nanoparticles have been created by a top-down fabrication method comprising applying a physical energy source to a source of bulk gold in a colloidal suspension liquid, said physical energy source comprising at least one of mechanical energy, heat energy, electric field arc discharge energy, magnetic field energy, ion beam energy, electron beam energy, laser ablation, or laser beam energy.

27. The electrolyte stable gold nanoparticles of claim 26 further comprising the step of first fabricating said source of bulk gold as a gold nanoparticle array on a substrate by photo electron beam deposition, focused ion beam deposition, or nanosphere lithography deposition and then using said gold nanoparticle array on said substrate as said source of bulk gold in said colloidal suspension liquid.

28. The electrolyte stable gold nanoparticles of claim 20 wherein said nanoparticles have at least one dimension in the range of from 1 to 200 nanometers.

29. The electrolyte stable gold nanoparticles of claim 20 wherein the shape of said nanoparticles comprises at least one of a sphere, a rod, a prism, a disk, a cube, a core-shell structure, a cage, a frame, or a mixture thereof.

30. The electrolyte stable gold nanoparticles of claim 20 wherein said nanoparticles are stable to aggregation beyond the threshold in an electrolyte composition comprising at least one of a phosphate buffer saline (PBS) solution, a buffer for High Performance Capillary Electrophoresis, a hydroxyethyl piperazineethanesulfonic acid (HEPES) sodium salt solution, a citrate-phosphate-dextrose solution, a phosphate buffer solution, a sodium acetate solution, a sodium chloride solution, a sodium DL-lactate solution, a tris(hydroxymethyl)aminomethane ethylenediaminetetraacetic acid (Tris-EDTA) buffer solution, a tris(hydroxymethyl)aminomethane (Tris) buffered saline, or mixtures thereof.

31. The electrolyte stable gold nanoparticles of claim 20 wherein said functional ligand comprises at least one of a polymer, a deoxyribonucleic acid nucleic acid sequence, a ribonucleic acid sequence, an aptamer, an amino acid sequence, a protein, a peptide, a peptide-nucleic acid, an enzyme, an antibody, an antigen, a fluorescent marker, a pharmaceutical compound, or a mixture thereof.

32. The electrolyte stable gold nanoparticles of claim 20 wherein at least one of said stabilizer component or said functional ligand, if present, is conjugated to said nanoparticles by at least one of a thiol group, an amine group, a phosphine group, an integrating molecule or a mixture thereof.

33. The electrolyte stable gold nanoparticles of claim 32 wherein said integrating molecule is selected from the group consisting of an antibody-antigen pair, an enzyme-substrate pair, a receptor-ligand pair, a streptavidin-biotin pair, a 1-ethyl-3-[3-dimethylaminopropyl]carbodiimide hydrochloride (EDC) and N-hydroxysulfosuccinimide (Sulfo-NHS) pairing, and mixtures thereof.

34. The electrolyte stable gold nanoparticles of claim 20 wherein said nanoparticles are a powder.
